(19) United States
(12) Patent Application Publication
(10) Pub. No.: US 2015/0310084 A1
(43) Pub. Date: Oct. 29, 2015

(54) METHOD AND APPARATUS FOR PROVIDING PHARMACEUTICAL CLASSIFICATION

(71) Applicant: Verizon Patent and Licensing Inc., Arlington, VA (US)

(72) Inventor: Madhusudan RAMAN, Sherborn, MA (US)

(73) Assignee: Verizon Patent and Licensing Inc., Arlington, VA (US)

(21) Appl. No.: 14/261,092

(22) Filed: Apr. 24, 2014

(51) Int. Cl. G06F 17/30

(52) U.S. Cl. CPC G06F 17/30598

(57) ABSTRACT

An approach is provided for pharmacological classification. A pharmaceutical classification platform receives an input associated with a phase of a pharmaceutical development cycle. The pharmaceutical classification platform performs a folksonomic tagging of the input to identify a target pharmaceutical compound, a target pharmacological effect, a target pharmacological parameter, or a combination thereof; and constructs a classification query based on the folksonomic tagging. The pharmaceutical classification platform then initiates an application of the classification query to a pharmacological data set; and discovers one or more linkages associated with the target pharmaceutical compound, the target pharmacological effect, the target pharmacological parameter, or a combination thereof based on a result of the classification query.

### BACKGROUND INFORMATION

The pharmaceutical industry ecosystem is currently undergoing structural changes designed to reduce the operational cost of finding, developing, manufacturing, and promoting new drugs, new applications of existing drugs, new therapies, and the like. For example, pharmaceutical research and development costs have been greatly increasing, often reaching over $1 billion to bring a new drug to market. As a result, service providers face significant technical challenges to enabling increased automation of research processes to reduce costs associated with pharmaceutical research.

Based on the foregoing, there is a need for an approach for machine-based pharmaceutical classification to support specialized research management for the pharmaceutical industry.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system capable of providing pharmaceutical classification, according to one embodiment;

FIG. 1B is a diagram illustrating a high level use case of the pharmaceutical classification platform, according to one embodiment;

FIG. 2 is a diagram of a system utilizing a pharmaceutical classification platform over a cloud network, according to one embodiment;

FIG. 3 is a diagram illustrating an overview of a cloud service provided by the pharmaceutical classification platform, according to one embodiment.

FIG. 4 is a diagram illustrating a summarized example of user content that can be analyzed for impact scoring, according to one embodiment;

FIG. 5 is a diagram of a folksonomic object scoring platform, according to one embodiment;

FIG. 6 is a flowchart of a process for providing pharmaceutical classification, according to one embodiment;

FIG. 7 is a flowchart of a process for deducing a model for pharmaceutical classification, according to one embodiment;

FIG. 8 is a flowchart of a process for presenting and scoring a discovered linkage, according to one embodiment;

FIG. 9 is a flowchart of a process for performing a digital assay based on pharmaceutical classification, according to one embodiment;

FIG. 10 is a diagram of a computer system that can be used to implement various exemplary embodiments; and

FIG. 11 is a diagram of a chip set that can be used to implement various exemplary embodiments.

### DESCRIPTION OF THE PREFERRED EMBODIMENT

A method, apparatus, and system for providing pharmaceutical classification are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

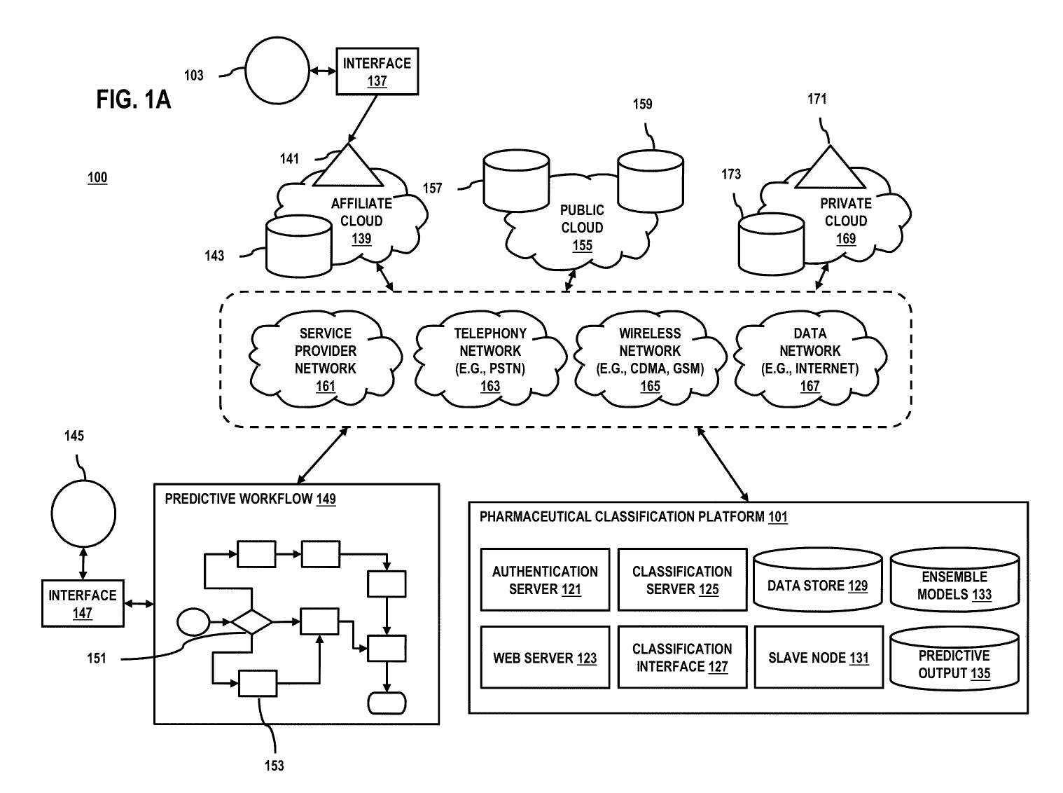

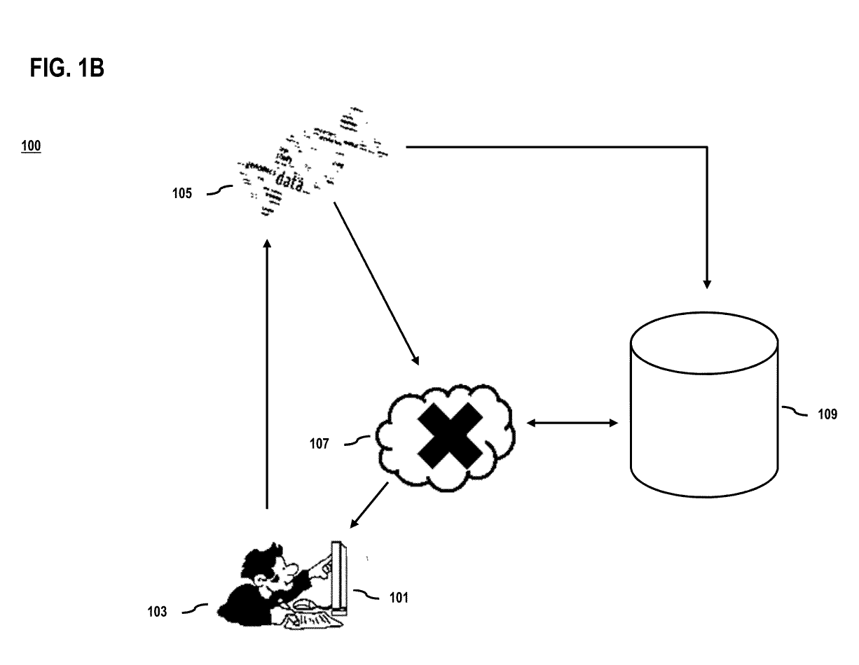

FIG. 1A is a diagram of a system capable of providing pharmaceutical classification, according to one embodiment. Generally, the life sciences industry (e.g., the pharmaceutical industry in particular) is faced with revenue pressures, and is turning to technology to optimize operations such as operations associated with researching and developing pharmaceuticals. Such research historically has often generated unstructured scientific and medical data that is expanding at an exponential rate, and that is originating from a multitude of public and private data sources. This proliferation of data has created a strong need for automated tools to manage and derive value from the growing body of data. As a result, investment in technologies that promote research and development innovation and collaboration is generally on the rise.

Another driver towards the need from increase data management tools in the pharmaceutical and life sciences industries is the sheer complexity of biological systems upstream or downstream from genetic code that plays a selective role in disease manifestation and treatment, thereby requiring specialized expertise and/or data across a variety of fields. Moreover, collaboration across these fields can be expected to create a complex fluid environment of researchers and data sources spanning various public and private organizations. For example, non-profit organizations, academic institutions, governmental research bodies, private companies, etc. participate in curating data regarding DNA sequences and protein structure. Because of the complex and distributed nature of the these data sets, it can potentially be very burdensome to gain significant insight from such public and private data sets to deliver significant gains in efficiency and productivity from the underlying research.

To address these problems, a system 100 of FIG. 1 introduces the capability to provide a cloud service that learns and assists pharmaceutical and life sciences industry collaborators with predictions that can accelerate research (e.g., pre-clinical research discovery for the pharmaceutical industry). By way of example and not limitation, that predictive targets of the pharmaceutical classification platform 101 include various pharmacological effects and pharmacological parameters such as toxicology properties, contextual physical properties, in vitro properties, in vivo coefficients, gene specific quantified properties, and the like. The pharmaceutical classification platform 101 furthers introduces the capability of performing a digital assay which, for instance, is a combination of properties to predict propensity of specific assays to be representative of a target pharmaceutical compound/structure/parameter moving to a next stage of a pharmaceutical development cycle without being rejected (e.g., moving beyond a clinical assay campaign).

In one embodiment, the system 100 provides cloud-based pharmaceutical assay screening using, for instance, folksonomic-based classification of available data sets (e.g., public and private data sets) to discover linkages derived from the properties of potential pharmaceutical compounds/structures/parameters/etc. and associated probe behavior on biological functions (e.g., a pharmacological effect). In addition, the system 100 can calculate or predict the propensity of such compounds/structure/parameters to be validated by a series of assays using the discovered linkages.

In one embodiment, the system 100 supports collaboration among researchers engaged in affiliate teaming arrangements by applying time expiration parameters or life time parameters to the discovered linkages. By way of example, the time expiration or life parameters may reflect contractual research terms specified in the affiliate teaming arrangements.

In one embodiment, the system 100 enables affiliated researchers can apply automated output classification training to trigger unsupervised machine learning in the cloud based on “federated linkages” (e.g., linkages between compounds and effects shared or specified by cooperating researchers or sources) available via, for instance, pre-competitive pharmacological knowledge framework application programming interfaces (APIs) on the public cloud.

In yet another embodiment, the system 100 uses the results of the pharmaceutical classification to automatically prioritize potential target compound assays using a predictively scored quantification for confirmation and high quality orthogonal assays using virtual rather than in vivo or in vitro techniques.

FIG. 1B is a diagram illustrating a high level use case of the pharmaceutical classification platform, according to one embodiment. More specifically, FIG. 1B depicts a use case of a researcher 103 using a digital assay performed via a pharmaceutical classification platform 101 rather than the traditional in vitro-in vivo approach. For example, the researcher 103 develops and tests hypotheses on the influence of different target compounds/structures/parameters (e.g., different chemical probes) on biological or pharmacological functions. In this example, the pharmaceutical classification platform 101 uses machine learning and processing to act as an “expert” based on self-discovering linkages (e.g., using predictive models) and having humans (e.g., the researcher 103) curate the discovered linkages and/or the linkage rules. In one embodiment, the discovered linkages are used in lieu of in vivo and in vitro experimentation to create predictions about a target compound/structure/parameter's propensity to survive the assay process in drug discovery.

As shown, a pharmaceutical classification platform 101 is being used by a researcher 103. In this example, the researcher 103 interacts with the pharmaceutical classification platform 101 to initiate a classification of the data set 105 to discover potential linkages that can be inferred from the data set 105. In response, the pharmaceutical classification platform 101 initiates an unsupervised classification of the data set and performs a validation of any specified or discovered test criteria based on the classification.

By way of example, the validation of test criteria can lead to potential predictions regarding any linkages discovered between compounds and pharmacological effects evident in the data set. Because the classification and validation is unsupervised, the pharmaceutical classification platform 101 may discover potentially hidden linkages or anomalies that are present in the data for validation and might not otherwise be easily recognizable. In addition, the platform 101 can apply folksonomic or other similar ontological vocabulary analysis to correlate or group synonymous compounds/structures even if the names used are different or the identities of the compounds/structures are otherwise obscured. In one embodiment, the platform can analyze the data set 105 to deduce the predictive or machine learning models that are most appropriate for the data set 105.

After validating discovered linkages, the pharmaceutical classification platform 101 generates a learning instance 107 of the pharmaceutical classification platform 101 to store the learned or discovered linkages. In one embodiment, the learned linkages are presented to the researcher 103 for curation via the learning instance 107. Once curated or if curation is not needed, the learned or discovered linkages are stored in the linkage repository 109 as persistent linkages or insights. In one embodiment, the linkages may be used by the researcher to prioritize compound assays or otherwise facilitate research activities.

Returning to FIG. 1A, the operation of the example components of the system 100 is discussed in greater detail below in the context of conducting affiliated or team-based research. In one embodiment, the system 100 includes a pharmacological classification platform 101 including the following components: an authentication server 121, a web server 123, a classification server 125, a classification interface 127, a data store 129, one or more slave nodes 131, an ensemble model store 133, and a predictive output 135. It is noted that the components of the pharmacological classification platform 101 are provided for illustration and are not intended to be limiting. In addition, one or more components may be combined in one component or performed by other components of the system 100.

As shown in FIG. 1A, an affiliated researcher 103 uses an authenticated interface 137 (e.g., a computing device) to access the affiliate cloud 139 of, for instance, a specific pharmaceutical company that the researcher 103 may be contracted with or collaborating with via the affiliate interface 141. In one embodiment, discovered linkages 143 are made persistent in the affiliate cloud 139 using, for instance, Resource Description Framework (RDF) specifications or other equivalent data representation including structured and unstructured data representations.

In one embodiment, discovered linkages 143 represent associations made, e.g., between a target compound/structure/parameter and a biological or pharmacological effect. In one embodiment, the linkages 143 are discovered using folksonomic classification of the compounds, structures, parameters, biological/pharmacological effects, and/or the like queried or analyzed from the underlying data sets.

When these discovered linkages 143 are annotated and elevated to an approved status by the affiliate researcher 103, the authentication server 121 initiates an authentication request on the pharmaceutical classification platform 101's cloud service. In one embodiment, a successfully authenticated dataset transaction is referred to as a discovered linkage and directed by the web server 123 to be made persistent on the classification server 125 of the pharmaceutical classification platform 101 via the classification interface 127 of the data store 129 (e.g., an unstructured Hadoop data platform or similar).

In one embodiment, the pharmaceutical classification platform 101 sets a timed expiration parameter or lifetime parameter associated with the life of a discovered linkage. In one embodiment, the discovered linkage leverages established W3C standards of the Vocabulary of Interlinked Datasets (VoiD) and the Vocabulary of Attribution and Governance (VOAG) to facilitate interoperability of data sets. For example, this is particularly important for research organizations or companies that have begun to source their discovery and pre-clinical research with external contract research organizations and ensure a clear cut ownership as a function of time on discovered linkages.

In one embodiment, the classification server 125 of the pharmaceutical classification platform 101 servers as the master Name and Data Node while the slave node 131 is used on jobs designated as multi-node. In one embodiment, ensemble models 133 are used to create the predictive output 135 associated with the discovered linkages. For example, when a pharmaceutical company researcher 145 (e.g., who is associated with the company teamed with the affiliate researcher 103) uses an authenticated interface 147 (e.g., a computing device) to discover “high propensity” molecules for a drug development pipeline, the company researcher 145 inputs predictive workflow 149 campaign to initiate discovery research using the pharmaceutical classification platform 101. In one embodiment, the predictive workflow 149 includes conditional flows 151 and specific assays 153.

In one embodiment, the pharmaceutical classification platform 101 can leverage other data linkages available in the public cloud 155 via, e.g., pre-competitive pharmacological framework APIs 157. By way of example, the other data linkages available in the public cloud 115 are referred to as federated linkages and are available from the publicly persisted resources 159. In one embodiment, the federated linkages can be co-mingled with the discovered linkages 143, for instance, to generate the predictive output 135.

To facilitate access by the researcher 103 and the researcher 145, the pharmaceutical classification platform 101 can initiate a secure connection via any of a service provider network 161, the telephony network 163, the wireless network 165, and the data network 167 to setup an instance of the company specific or private cloud 169. By way of example, the private cloud 169 (e.g., generated by a company specific instance of the pharmaceutical classification platform 101) is accessed via the cloud interface 171. In one embodiment, the pharmaceutical classification platform 101 can store any discovered linkages specific to the private cloud 169 in the private linkages store 173. In this way, the pharmaceutical classification platform 101 has access to discovered linkages 143 from the affiliate cloud, federated linkages 159 from the public cloud 155, and private discovered linkages 173 from the private cloud 169.

In one embodiment, the classification interface 127 of the pharmaceutical classification platform 101 is used to trigger an end-to-end digital assay (e.g., spanning the affiliate cloud 139, the public cloud 155, and the private cloud 169) scoring to determine a target compound/structure/parameter's propensity to make it to a next state in the research funnel or pharmaceutical development cycle. The digital assay is performed on different target compounds/structures/parameters and aggregated scores are used to identify and/or prioritize the candidate sets that are most likely to proceed through the research funnel or development cycle. In one embodiment, the scoring is based on a folksonomic classification and analysis of relevant data sets.

Although the various embodiments and examples described here in relate to the discovery phase of a pharmaceutical development cycle, it is contemplated the various embodiments are also applicable to any other stage of pharmaceutical development and/or research in general. For example, Table 1 below lists other example phases of the pharmaceutical development and potential application of the pharmaceutical classification platform 101 to those phases.

| Product | | Core | Platform | Use Case |
|---|---|---|---|---|
| Lifecycle | Business Processes | Feature | Feature | Example |
| Discovery & | Drug discovery | Knowledge | Unsupervised | Compound/ |
| Pre-Clinical | Decision support | Extrapolation | Learning | Target/ |
| Research | Content analytics | | | Enzyme - |
| | Target biomarker | | | Class |
| | discovery | | | Pharmacology |
| | Genetics analysis | | | Toxicology |
| Clinical | Clinical trial planning | Propensity | Supervised | Target |
| Research | Clinical trial budgeting | Screening | Classification | Pharmacology |
| | Clinical trial forecasting | | | |
| | Opportunity scouting | | | |
| | Adverse event selection | | | |
| Manufacturing | Demand forecasting | Trend | Anomaly | Ad Hoc |
| & Distribution | Supply chain analytics | identification | Detection | Notification |
| | Inventory optimization | | | |
| Sales & | Sales force optimization | Campaign | Contextual | Campaign |
| Marketing/Post | Promotional spend | Management | Marketing | Effectiveness |
| Marketing | reporting | | | Tracking |
| | Brand health analysis | | | |
| | Affine Group Targeting | | | |

As previously described, in one use case, the system 100 assists researchers by introducing predictive scoring of target compounds/structures/parameters based on their respective propensity to be validated at a next phase of pharmaceutical development or research. In one embodiment, this propensity information is determined by analysis of data sets for underlying linkages between the target and a pharmacological effect using folksonomy. In this way similar target compounds/structures/parameters can be grouped for analysis even if they are identified differently across different data sets or even within the same data set. By way of example, folksonomy broadly refers to a process for classifying content (e.g., digital media, postings, documents, etc.) based on collaborative creation and management of content tags. Folksonomy includes, for instance, classifying user content (e.g., consumer posts or topics) using their own tags and terms until a usable structure (e.g., a folksonomic vocabulary) emerges.

In one embodiment, there are at least two types of folksonomy: a broad folksonomy and a narrow folksonomy. A broad folksonomy, for instance, is one in which multiple users tag particular content with a variety of terms from a variety of vocabularies, thus creating a greater amount of metadata for that content. A narrow folksonomy, on the other hand, occurs when a few users, primarily the content creator, tag an object with a limited number of terms. In either case, folksonomy relies, in part, on the idea that analysis of the complex dynamics of tagging systems has shown that consensus around stable distributions and shared vocabularies emerge, even in the absence of a central controlled vocabulary. In one embodiment, the system 100 leverages this folksonomic vocabulary to provide pharmaceutical classification and linkage discovery for predictive scoring. In one embodiment, the system 100 provides predictive scoring services that support hybrid data segmentation (e.g., combining static and dynamic segments), cost function driven data wake spidering (e.g., via direct APIs or other interfaces to relevant data sets), and a bridging of traditional web segments with public and private cloud data.

In one embodiment, the pharmaceutical classification platform 101 uses the vector definitions to score the data store 129 and/or other relevant databases (e.g., comprising various relevant data sets, user content streams from the public internet, mobile application space, third party streams, etc.) continuously, at regular intervals, according to a schedule, and/or on demand for relevancy to a target compound/structure/parameter and associated pharmacological effects. For example, relevancy can be determined by lexical and/or semantic analysis of mentions related to the target compound/structure/parameter and associated pharmacological effects. In one embodiment, the pharmaceutical classification platform 101 can also update the vector definitions iteratively based on the results of the scoring and/or reclassification of data segments.

In one embodiment, the pharmaceutical classification platform 101 can predict validation scores for a target compound/structure/parameter, for instance, tracking or monitoring discovered linkages determined from relevant data sets. The predictive scoring, for instance, leverages both inductive and deductive reasoning based on various predictive models. In one embodiment, the models are ensemble models comprising multiple models of multiple types (e.g., experiential models such as neural networks, regression models, etc.). In one embodiment, the models adhere to the Predictive Modeling Markup Language (PMML) standard. By way of example, the ensemble models of the system 100 support a combination of data-driven insight and expert knowledge into a single and powerful decision strategy. Neural network models, for instance, encapsulate “experiential” rules used by experts to provide impact scoring for concepts or brands (e.g., expert knowledge). Then predictive analytics augments the experiential rules based on an ability to automatically recognize patterns in data not obvious to the expert eye. As a result, the ensemble model approach described herein uses more than one model to arrive at a consensus classification or impact scoring for a given set of user content data.

For illustrative purposes, the pharmaceutical classification platform 101 and other components of the system 100 have connectivity via one or more of networks 161-167. In one embodiment, the networks 161-167 may be any suitable wireline and/or wireless network, and be managed by one or more service providers. For example, telephony network 119 may include a circuit-switched network, such as the public switched telephone network (PSTN), an integrated services digital network (ISDN), a private branch exchange (PBX), or other like network. Wireless network 121 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 123 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, the networks 161-167 may be completely or partially contained within one another, or may embody one or more of the aforementioned infrastructures. For instance, the service provider network 161 may embody circuit-switched and/or packet-switched networks that include facilities to provide for transport of circuit-switched and/or packet-based communications. It is further contemplated that the networks 161-167 may include components and facilities to provide for signaling and/or bearer communications between the various components or facilities of system 100. In this manner, the networks 161-167 may embody or include portions of a signaling system 7 (SS7) network, or other suitable infrastructure to support control and signaling functions.

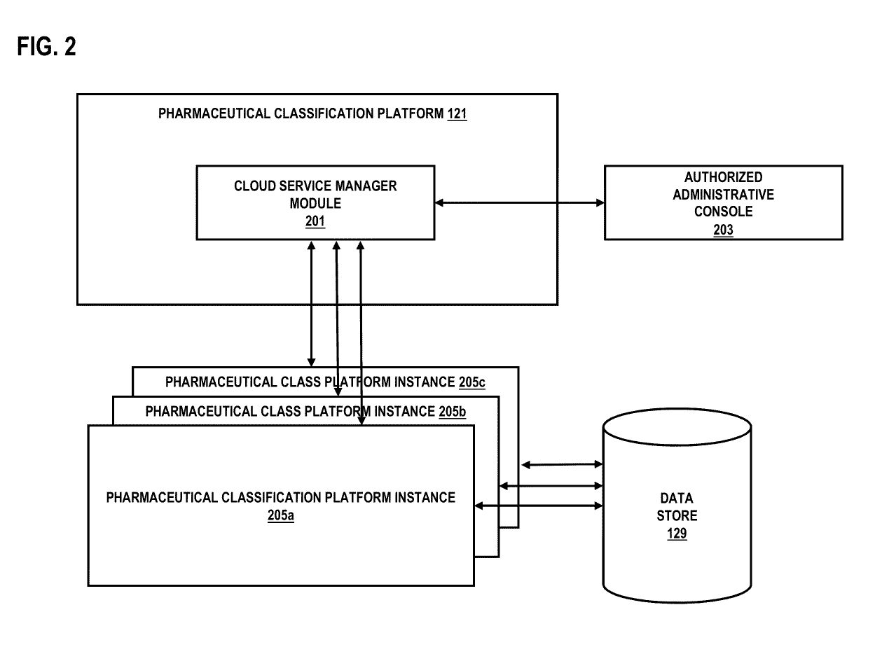

FIG. 2 is a diagram of a system utilizing a pharmaceutical classification platform over a cloud network, according to one embodiment. In one embodiment, the pharmaceutical classification platform 101 can be implemented as a managed cloud-based service that can be made private and/or rebranded based on a research organization's or a company's needs. Accordingly, the pharmaceutical classification platform 101 can mix and match various elements from different instances of the service. For example, the platform 101 can mix and match instances of the service corresponding to different research affiliates, thereby supporting new discoveries for pharmaceutical applications that leverage experimental data from past assay outcomes from the participating affiliates.

Accordingly, in one embodiment, the pharmaceutical classification platform 101 can be instantiated as a cloud service. In a cloud-based embodiment, the pharmaceutical classification platform 101 is controlled by a cloud service manager module 201. The authorized administrative console 203 is used to access the cloud service manager module 201 to use the cloud service manager module 201 to create instances 205a-205c (also collectively referred to as instances 205) of the pharmaceutical classification platform 101 for a channel partner.

The cloud service manager module 201 generates an instance 205 of the pharmaceutical classification platform 101 on demand in association with a channel partner. Each instance 205 of the pharmaceutical classification platform 101 gives the channel partner requesting access through the cloud network the ability to manage the services provided. These services include pharmaceutical classification, knowledge extrapolation, propensity scoring, trend identification, campaign management, and the like.

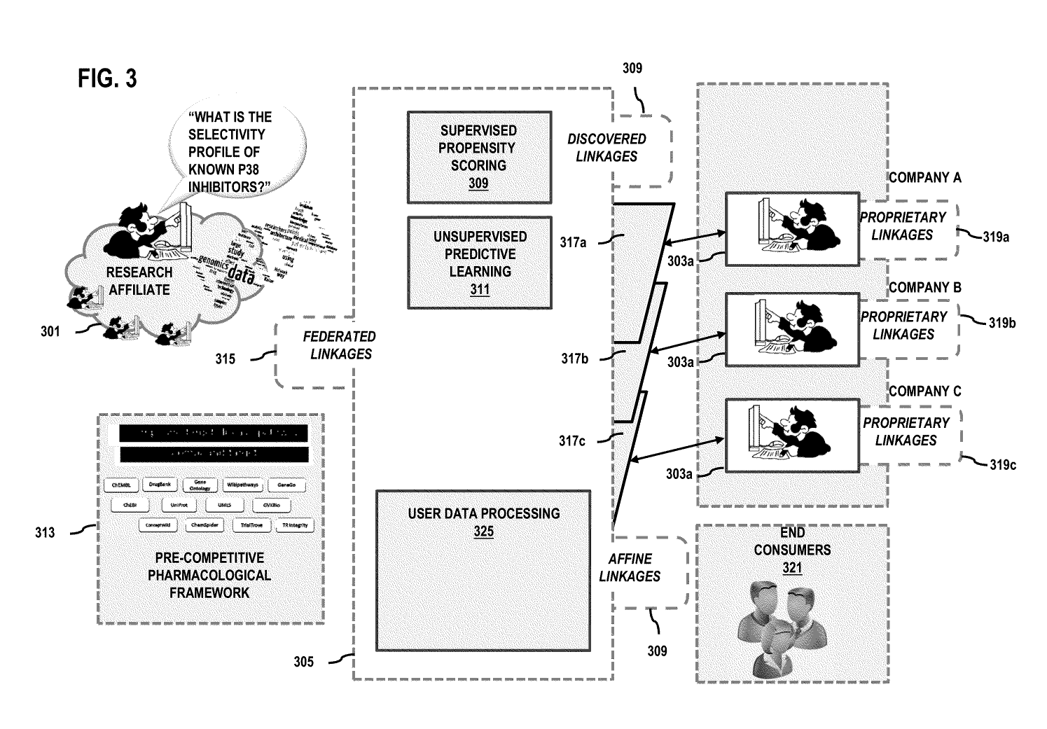

FIG. 3 is a diagram illustrating an overview of a cloud service provided by the pharmaceutical classification platform, according to one embodiment. The example FIG. 3 shows a use case in which affiliate researcher 301 work cooperatively with company researchers 303a-303c associated with respectively with Company A, Company B, and Company C. For example, affiliate researchers are interacting with a public instance 305 of the pharmaceutical classification platform 101, as well as with respective private instances 307a-307c of the pharmaceutical classification platform 101 service instantiated respectively for Company A, Company B, and Company C.

As shown, the affiliate researchers are interacting with the instance 305 to investigate “What is the selectivity profile of known P38 inhibitors?” In response to this request or input, the instance 305 performs a folksonomic tagging of the request (e.g., P38 inhibitors, selectivity profile, etc.) to initiate a classification query of the data sets available to the research affiliates. In one embodiment, classification query supports initiating a digital assay screening process for the terms parsed from the initial input. The classification query results in determining one or more discovered linkages 309 based on analytical techniques such as supervised propensity scoring, unsupervised predictive learning, as well as other unsupervised and supervised techniques. As previously described, the linkages represents potential relationships between a pharmaceutical compound (e.g., P38 inhibitors) and their biological or pharmacological effect (e.g., selectivity). In one embodiment, the predictive models can be deduced from the data sets themselves based on results of the classification query, so that the instance 305 can employ the analytical model or technique most suited to a given data set.

In addition, the instance 305 may access public data via a pre-competitive pharmacological framework 313 for processing against the initial inputs from the affiliate researchers 301. The processing of the public data, for instance, results in determining of federated linkages (e.g., relationships indicated by data available from the public cloud).

At the same time, e.g., depending on teaming or contractual terms, the respective company researchers 303a-303c may also engage in investigating the same topic as the affiliate researchers 301. In this case, each company researcher 303a-303c is operating within their own respective private instances 317a-317c of the pharmaceutical classification platform 101 service. In this example, each Company A-C is maintains any linkages discovered in their respective private instances 317a-317b as proprietary linkages 319a-319c that is kept private (e.g., with respect to other company researchers 303a-303c, the public, as well as the affiliate researchers 301a-301b).

In one embodiment, the respective instances 317a-317c of the pharmaceutical classification platform 101 can combine the discovered linkages 309, federated linkages 315, and respective proprietary linkages 319a-319c to reach different predictive scoring or insights for each Company A-C depending on the linkage data available to the instances 317a-317c. In one embodiment, the any of the discovered linkages 309, federated linkages 315, and/or proprietary linkages 319a-319c may be associated with a timed expiration or other life parameter. For example, such linkage data may be timed to expire with the expiration of a teaming or contractual agreement. Such information along with other ownership information may be associated with the linkages using applicable standards such as VoiD and VOAG.

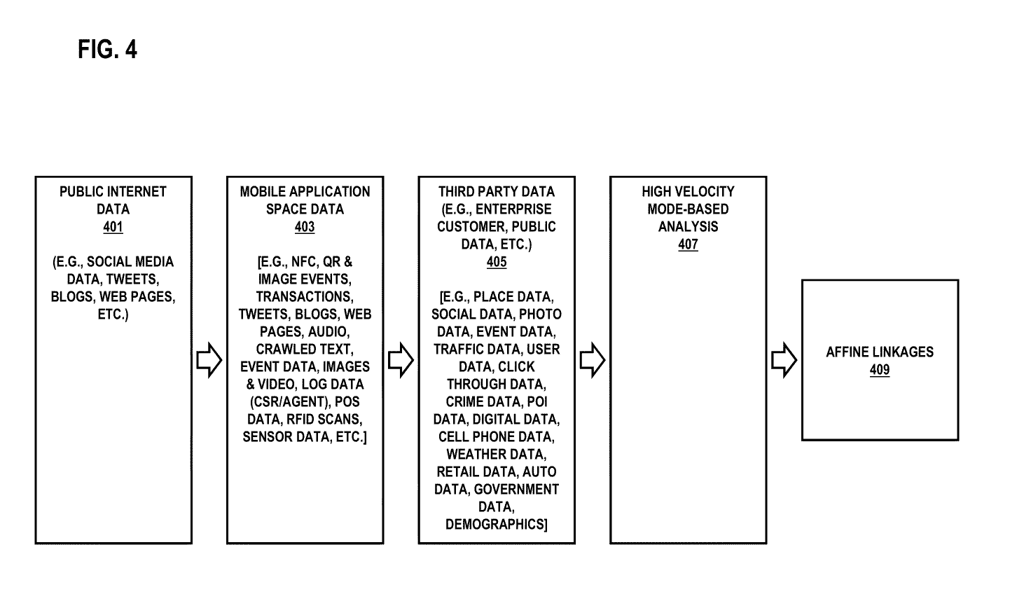

In one embodiment wherein user data from end consumers 321 are available as part of the relevant data set, the pharmaceutical classification platform 101 can leverage the user data to segment the relevant data set according to user characteristics (e.g., demographics, medical history, life style, etc.) to determine affine linkages 323 by a user data processing 325. By way of example, the affine linkages 323 can be used to target or investigate specific populations (e.g., based on user characteristics) that may have particular characteristics of interest or characteristics that are shown to be linked to a particular efficacy, pharmacological effect, etc. associated with a target compound/structure/parameter. Processing of user data is described in more detail with respect to FIG. 4 below.

In one embodiment, the affine linkages 323 enable the pharmaceutical classification platform 101 to personalize cloud learning to tailor pharmaceutical classification to specific populations or even individuals. In one embodiment, consumer specific readings (e.g., from wearable health sensors and similar devices) can impact which affine group classifiers are used for the classification of a specific individual using a specific device. For example, houses that are a certain number of years old might be an affine group versus much younger homes or much older homes. As another example, women of a certain age may form an affine group (e.g., for alcohol consumption patterns) versus men. These affine groups are learned and then anonymized meta-data can be retained as part of the affine linkages 323 data. In one embodiment, underlying readings or characteristics that were used to determine the affine groups can be discarded for privacy considerations once the anonymized affine linkages 323 are determined.

FIG. 4 is a diagram illustrating user data processing for determining affine linkages, according to one embodiment. In one embodiment, user content (e.g., health sensor readings from wearable devices, text, audio, images, videos, etc.) attributable to digital-consumer activity can provide a cohesive snapshot of the profile of a user albeit in a terms of a big and unstructured real-time flow of information. The pharmaceutical classification platform 101 taps into this flow to provide “here and now insight” that ties user affine groupings to predict user reaction or response to target pharmaceutical compounds/structures/parameters. For example, user data may reveal hidden or subtle relationships between a user characteristic or affine grouping and a pharmacological effect from a target compound/structure/parameter.

As shown in FIG. 4, an example user content flow includes user content from public internet data 401, mobile application space data 403, and third party data 405. Examples of user content from public internet data 401 include social media data, tweets, blogs, web pages, and the like. Examples of mobile application space data 403 include user content collected directly from a user device 113 and/or the applications executing on the device 113. Such mobile application space data 403 also includes data collected from wearable or snappable devices (e.g., personal health sensors) associated with user devices.

Mobile application space data 403 include, for instance, application activity, application generated content, etc. such as near field communication (NFC) events, quick response (QR) code reading, image events, transactions, tweets sent from native applications, blogs generated from native applications, web pages accessed via native applications, audio, images, videos, crawled text, event data, log data (e.g., generated from interactions with customer service representatives or agents), point of sale (POS) data, radio frequency identification (RFID) scans, sensor data, and the like. In one embodiment, the system 100 accesses mobile application space data 403 without requiring changes to the applications executing at the device 113. Instead, the system 100 can access application space data 403 through techniques typically reserved for the other two data categories 401 and 405.

In one embodiment, third party data 405 includes enterprise customer data, public data, vendor data, and the like. Examples of third party data 405 include place data, social data, photo data, event data, traffic data, user data, click through data, crime data, point-of-interest (POI) data, digital data, cell phone data, weather data, retail data, vehicle (e.g., auto) data, government data, demographics, and the like.

In one embodiment, the data flow comprising the public internet data 401, the mobile application data 403, and/or the third party data 405 are scored via high velocity mode-based analysis 407 to generate affine groupings and/or discover affine linkages 409 with respect to target compounds/structures/parameters. By way of example, the high velocity mode-based analysis 407 includes correlation, clustering, pattern analysis, segmentation, semantic analysis, sentiment analysis, social analysis, trend analysis, ontological analysis, and the like. In one embodiment, the pharmaceutical classification platform 101 is implemented as a machine-to-physical (M2P) platform that leverages scoring and predictive services based on various models (e.g., ensemble predictive models as described above). In one embodiment, the predictive models can be customized for a particular customer or enterprise, deduce from a data set, and/or automatically tuned according to a user's affine groupings.

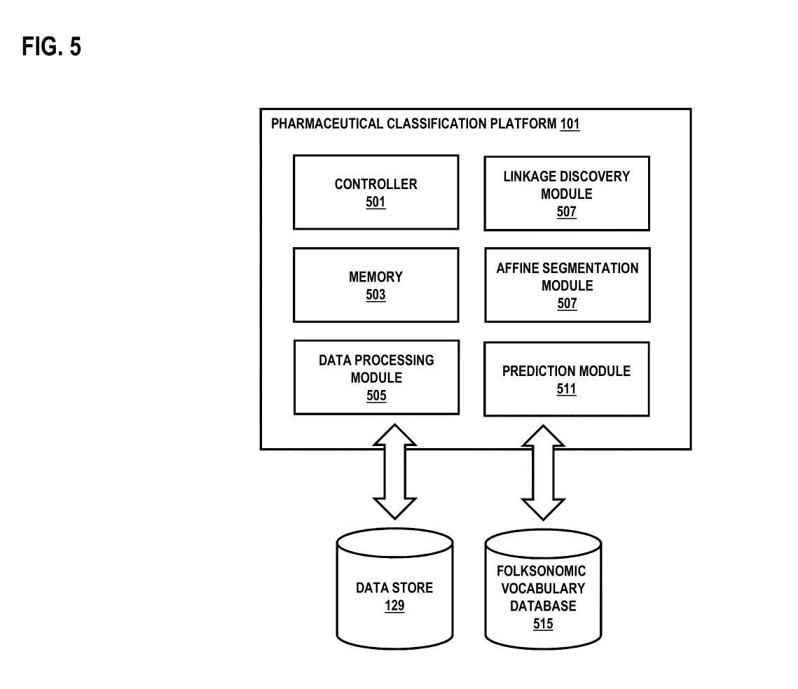

FIG. 5 is a diagram of a pharmaceutical classification platform, according to one embodiment. By way of example, the pharmaceutical classification platform 101 includes one or more components for providing pharmaceutical classification functions including, but not limited to, pharmaceutical assay screening, folksonomic classification, linkage discovery, output classification training, automated prioritization of target compounds/structures/parameters, propensity scoring, etc. It is contemplated that the functions of these components may be combined in one or more components or performed by other components of equivalent functionality. In this embodiment, in addition to the components described with respect to FIG. 1A above, the pharmaceutical classification platform 101 (e.g., via the classification server 125) includes a controller 501, a memory 503, data processing module 505, a linkage discovery module 507, a affine segmentation module 509, a scoring module 511, a prediction module 513, and a folksonomic vocabulary database 515. In one embodiment, the pharmaceutical classification platform 101 also has access to the data store 129.

The controller 501 may execute at least one algorithm (e.g., stored at the memory 503) for executing functions of the pharmaceutical classification platform 101. For example, the controller 501 may interact with the data processing module 505 to process public and private data sets (e.g., from the data store 129, the affiliate cloud 139, the public cloud 155, and/or the private cloud 169) to determine discovered linkages between target compounds/structures/parameters and a biological or pharmacological effect. For example, relevant data sets may include unstructured research data bases including study data, research papers, articles, etc. In one embodiment, data sets may also include user data for determining affine grouping and linkages (e.g., health sensor data, social media, web, survey, operational, and transactional data). By way of example, user data can span any number of data spaces including the public internet, private device application space, and third party data sources along with enterprise transactional and operational support data.

In one embodiment, the data processing module 505 uses lexical analysis, semantic analysis, sentiment analysis, etc. (e.g., as described above with respect to the analysis 407 of FIG. 4) to perform automated and machine learned parsing of relevant data sets. In one embodiment, the data processing module 505 may determine the extent of relevant data sets to process based on specified preferences and/or a cost function. The cost function, for instance, may specify thresholds for resources (e.g., memory, computational resources, monetary resources, bandwidth resources, etc.) that are to be used for content processing. Based on the thresholds and/or resource availability, the data processing module 505 can determine when to start or stop data processing including how much of the data to process. It is contemplated that the data processing module 505 may use any textual recognition, image recognition, object recognition, audio recognition, speech recognition, etc. techniques for identifying potential text, images, audio, and the like from relevant data sets. The user content processing module 505 then analyzes the potential mentions of potential target compounds/structures/parameters and/or biological or pharmacological effects against the folksonomic vocabulary database 515 to determine whether the mentions relate to a potential linkage.

The data processing module 505 then interacts with the linkage discovery module 507 determine whether there is a correlation between a target compound/structure/parameter and an associated effect to determine a linkage. In one embodiment, the scoring module 507 can apply validation criteria and/or testing criteria to determine a linkage. By way of example, the determination of a linkage can also be based on supervised and/or unsupervised learning.

In one embodiment, the pharmaceutical classification platform 101 includes the affine segmentation module 507 to perform static segmentation, dynamic segmentation, or a hybrid static/dynamic segmentation of relevant data sets based on user characteristics. For example, the affine segmentation module 507 enables a user (e.g., a researcher) to specify segmentation seeds to initiate the process of dynamic segmentation. In one embodiment, the segmentation seeds are static segments that are, for instance, demographics-based. The affine segmentation module 509 uses the static segments as a starting state. Then as additional data or content is processed and new segments are discovered the segmentation module 509 can dynamically update the starting state to reflect discovered segments associated with particular affine groupings. The affine segmentation module 507 can then automatically tune classification or predictive models based on the characteristics of the affine groupings.

In one embodiment, the pharmaceutical classification platform 101 includes a prediction module 511 for providing predictive insights into determined or discovered linkages. For example, the prediction module 511 uses ensemble predictive models to calculate a propensity scoring for target compounds/structures/parameters, perform knowledge extrapolation to infer effects from one compound class to another, identify trends in the data, and/or monitor user response to targeted compounds and/or campaigns associated with the compounds. For example, the prediction module 511 combines linear regression and neural network models into a predictive scorecard. In one embodiment, the predictive models leverage a PMML cloud-based engine such as the Adaptive Decision and Predictive Analytics (ADAPA) engine. In one embodiment, the model's data dictionary contains all the definitions for data fields (input variables) used in the model. The dictionary also specifies the data field types and value ranges. In PMML, the content of a “Data Field” element defines the set of values which are considered to be valid or default parameters. Each PMML model also contains one “Mining Schema” which lists fields used in the model.

In one embodiment, the neural network model represent a model trained by the use of a back propagation algorithm. For example, a neural network model is composed of an input layer, one or more hidden layers and an output layer. In one embodiment, the model used by the prediction module 511 is composed of an input layer containing many input nodes, multiple hidden layers with neurons, and an output layer with output neurons. All input nodes are connected to all neurons in the hidden layer via connection weights. By the same extent, all neurons in the hidden layer are connected to the output neuron in the output layer. Each neuron receives one or more input values, each coming via a network connection, and are contained in the corresponding neuron element. Each connection of the element neuron stores the ID of a node it comes from and the weight. A bias weight coefficient or a width or a radial basis function unit may also be stored as an attribute of the neuron element.

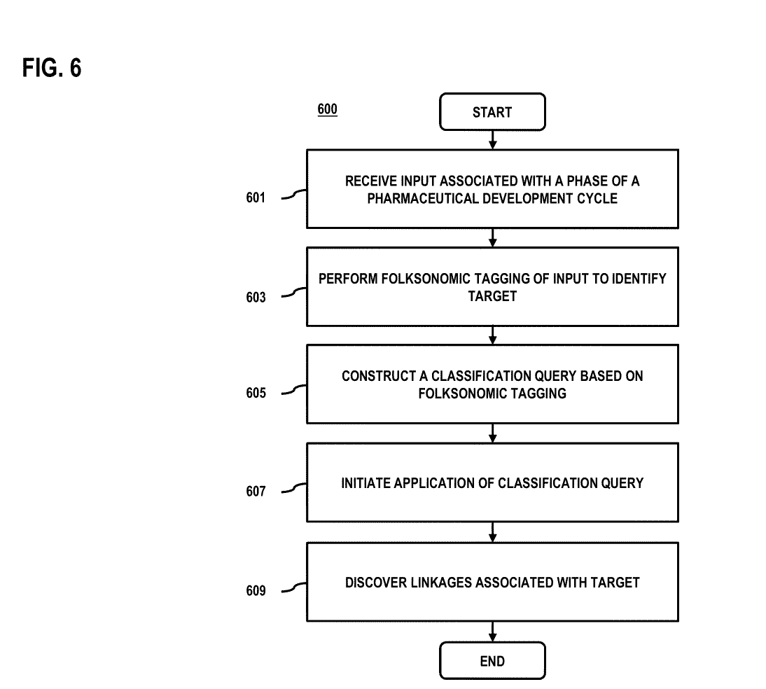

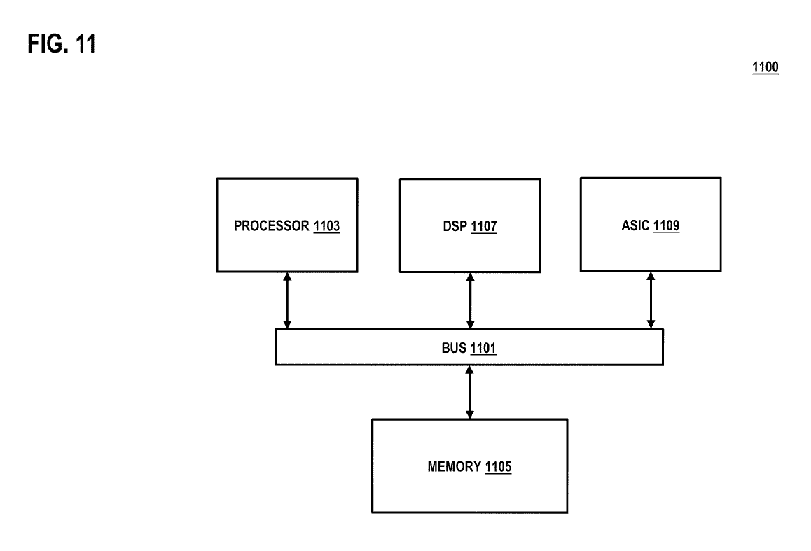

FIG. 6 is a flowchart of a process for providing pharmaceutical classification, according to one embodiment. In one embodiment, the pharmaceutical classification platform 101 performs the process 600 and is implemented in, for instance, a chip set including a processor and a memory as shown in FIG. 11.

In step 601, the pharmaceutical classification platform 101 receives an input associated with a phase of a pharmaceutical development cycle. As previously discussed, although many of the embodiments described herein relate to the discovery phase of the pharmaceutical development cycle, the federated cloud based services of the pharmaceutical classification platform 101 can be applied to many uses across the entire span of the drug lifecycle from discovery and pre-clinical research to sales and marketing. As a result, the pharmaceutical classification platform 101 has a flexible interaction input system whereby the applicable development phase can be used as context for interpreting a given input. For example, if a target compound, structure, or parameter is specified during a discovery phase, the pharmaceutical may interpret the input as a request for propensity scoring. Whereas if the same target is specified in a marketing, the pharmaceutical classification platform 101 may interpret the input as a request for a campaign effectiveness analysis or a trend analysis.

In step 603, the pharmaceutical classification platform 101 performs a folksonomic tagging of the input to identify a target pharmaceutical compound, a target pharmacological effect, a target pharmacological parameter, or a combination thereof. To provide for further flexibility, the pharmaceutical classification platform 101 can use folksonomy to determine terms that should be used for the classification query. More specifically, folksonomy can use supervised or unsupervised tagging to determine what concepts, structures, effects, etc. are related even if different terms or identifiers are used. For example, synonyms used for the same compound or structure can be automatically parsed. In some cases, lexical or semantic analysis can be applied to determine common terms. In this case, all terms specified in the input to the platform 101 can be tagged and categorized as a compound, a structure, or a parameter (e.g., dose, mode of application, interactions, etc.) associated with the target.

In step 605, the pharmaceutical classification platform 101 constructs a classification query based on the folksonomic tagging. In this example, the classification query may include all folksonomically related terms to increase a likelihood of returning relevant results from explored data sets. In one embodiment, the folksonomic terms may be specified in a classification record to form the classification query.

In step 607, the pharmaceutical classification platform 101 initiates an application of the classification query to a pharmacological data set. In one embodiment, the application of the classification query is performed via a cloud-based server using an unsupervised predictive model, a supervised predictive model, or a combination thereof. For example, such data-driven analytics can potentially recognize patterns (e.g., linkages) in data that would otherwise be not obvious to even human experts.

In one embodiment, the pharmacological data set may be stored using a standard model for interchange of structured or unstructured data such as the W3C RDF or other similar data standard. For example, RDF has features that facilitate interchange of public and private pharmacological data resources on the Web. More specifically, RDF has features that facilitate data merging even if the underlying schemas differ, and it specifically supports the evolution of schemas over time without requiring data consumers (e.g., pharmacological data providers and/or receivers) to be changed. For example, the OpenPhacts pharmacological database uses RDF and VoiD, and can be used as part of a competitive framework via their API. Accordingly, a pharmacology query using the OpenPhacts API is able to draw data from a variety of sources including, e.g., Chembl, ChemSpider, ConceptWiki, and Drugbank, thereby enabling access to pharmacology, chemistry, disease, pathways, and other database without having to perform complex mapping operations.

In step 609, the pharmaceutical classification platform 101 discovers one or more linkages associated with the target pharmaceutical compound, the target pharmacological effect, the target pharmacological parameter, or a combination thereof based on a result of the classification query. As previously discussed, in one embodiment, linkages are derived from determined relationships (e.g., based on the classification query of relevant data sets) between a target compound's chemical properties and associated probe behavior on biological functions or other pharmacological effect.

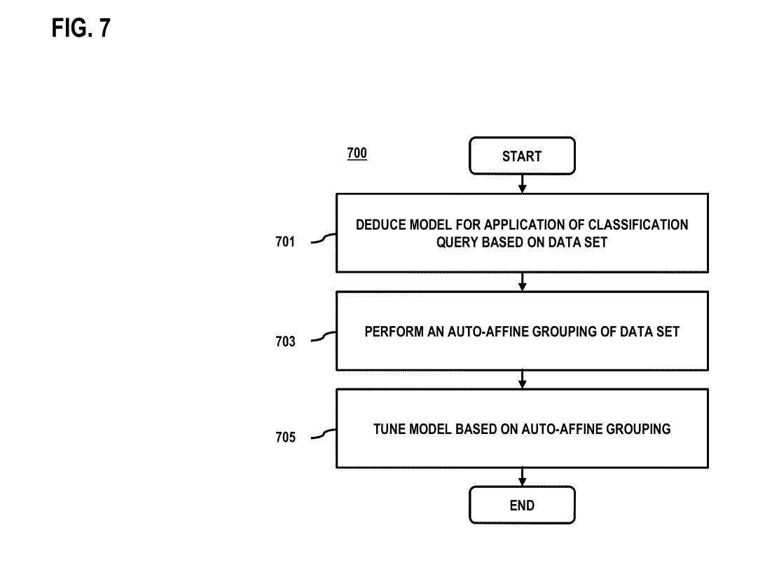

FIG. 7 is a flowchart of a process for deducing a model for pharmaceutical classification, according to one embodiment. In one embodiment, the pharmaceutical classification platform 101 performs the process 700 and is implemented in, for instance, a chip set including a processor and a memory as shown in FIG. 11.

In step 701, the pharmaceutical classification platform 101 deduces a model for the application of the classification query based on the pharmacological data set. In one embodiment, the pharmaceutical classification platform 101 automates the process of selecting a learning model to apply for pharmaceutical classification. For example, the platform 101 can use deduce the model type to be used based on what data set is under evaluation (e.g., have been uploaded to the cloud service). More specifically, the pharmaceutical classification platform 101 considers a series of questions that themselves are part of a learning model to determine which models are appropriate for a given data set. In one embodiment, as part of the deduction process, the pharmaceutical classification platform 101 looks at patterns of the feature being quantified and contextually classifies the feature into an actionable state based on a predetermined threshold. In this case the feature to be put into an actionable state is one or more learning models that can be potentially applied. If the patterns of the feature related to a particular model reaches the threshold then the platform 101 selects the model to apply to the data set. In one embodiment, it is contemplated that the different models can be selected and applied to different portions of the same data set.

In step 703, the pharmaceutical classification platform 101 performs an auto-affine grouping of the pharmacological data set. When data about users contributing to a pharmacological data set is available, the pharmacological classification platform 101 can process the user data to segment the data according to affine groupings associated with different characteristics of the users. Because the affine grouping may be performed using unsupervised learning and models, such affine groupings need not be human understandable (e.g., correlate to known characteristics or types such as age, income, domicile, etc.). By performing auto-affine grouping, the platform 101 can potentially identify particular populations of interest (e.g., populations with greater or lesser pharmacological effects) to add in selecting test populations, etc. when proceeding to clinical trials.

In step 705, the pharmaceutical classification platform 101 tunes the model based on the auto-affine grouping. In one embodiment, tuning the model includes applying affined-based transformations to model parameters or to the data set itself. For example, an affine transformation may specify a transformation that includes shifting or scaling data points by a particular amount for certain affine groupings.

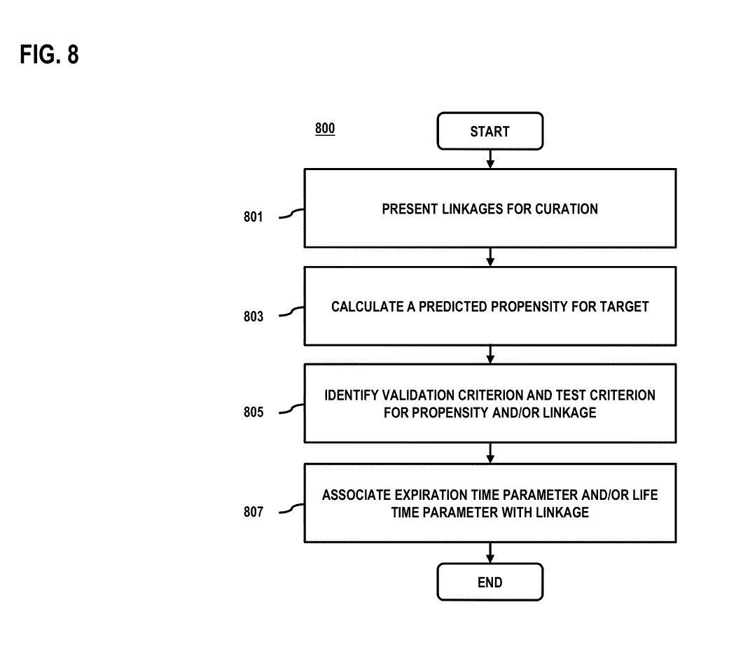

FIG. 8 is a flowchart of a process for presenting and scoring a discovered linkage, according to one embodiment. In one embodiment, the pharmaceutical classification platform 101 performs the process 800 and is implemented in, for instance, a chip set including a processor and a memory as shown in FIG. 11.

In step 801, the pharmaceutical classification platform 101 presents the one or more linkages via a user interface for a user curation of the one or more linkages. In one embodiment, the platform 101 may be configured to request human confirmation of discovered linkages. For example, before a discovered linkage is made persistent in a linkage store, confirmation may be requested from an expert users. In some embodiments, the pharmaceutical classification platform can be configured to operate completely autonomously, whereby discovered linkages are automatically recorded or stored to persistent storage.

In step 803, the pharmaceutical classification platform 101 calculates a predicted propensity for the target pharmaceutical compound, the target pharmacological effect, the target pharmacological parameter, or a combination thereof based on the application of the classification query, the one or more linkages, or a combination thereof. In one embodiment, the predicted propensity represents a probability that the target pharmaceutical compound, the target pharmacological effect, the target pharmacological parameter, or a combination thereof will be validated with respect to the pharmaceutical development cycle. As previously discussed, the pharmaceutical classification platform 101 can apply ensemble models to predictively score the targets for their propensity to successfully advance to a next phase of research or pharmaceutical development.

In step 805, the pharmaceutical classification platform 101 identifies a validation criterion, a test criterion, or a combination thereof associated based on the application of the classification query, the one or more linkages, or a combination thereof. In one embodiment, the predicted propensity is calculated based on the validation criterion, the test criterion, or a combination thereof. For example, the pharmaceutical classification platform 101 uses data analysis to test various hypotheses (e.g., validation criterion, test criterion) regarding a validity of a discovered linkage. As described above, the platform 101 can deduce the models, linkage rules, etc. using yet other specific learning models that include questions and criteria for evaluating the applicability of such models or rules to certain types of data sets.

In step 807, the pharmaceutical classification platform 101 associates an expiration time parameter, a life time parameter, or a combination thereof with the one or more linkages. One feature of the pharmaceutical classification platform is a capability to apply timed expiration and/or specify a life time for determined linkage. For example, such expiration or life time parameter can be based on contractual or teaming agreements that may limit the time period for cooperation between affiliate and company researchers. In other cases, such expiration can be set based on the nature of the data (e.g., whether a data set may become stale or no longer applicable or relevant).

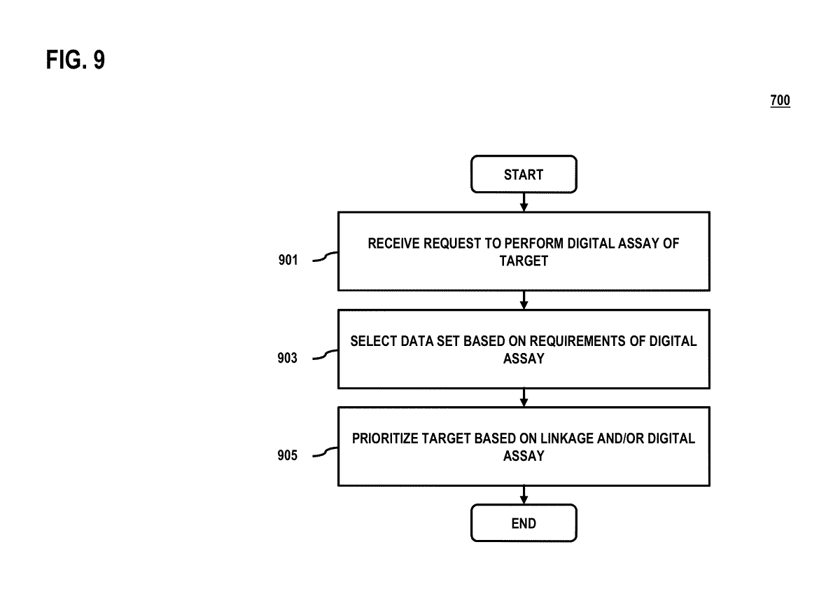

FIG. 9 is a flowchart of a process for performing a digital assay based on pharmaceutical classification, according to one embodiment. In one embodiment, the pharmaceutical classification platform 101 performs the process 900 and is implemented in, for instance, a chip set including a processor and a memory as shown in FIG. 11.

In step 901, the pharmaceutical classification platform 101 receives a request to perform a digital assay of the target pharmaceutical compound, the target pharmacological effect, the target pharmacological parameter, or a combination thereof. In one embodiment, the pharmaceutical classification platform 101 uses the results of the classification query and determined linkages to mine available data to perform a virtual or digital assay regarding target compounds/structures/parameters and their associated pharmacological effects.

In step 903, the pharmaceutical classification platform 101 selects the pharmacological data, an interface for accessing the pharmacological data, or a combination thereof based on one or more requirements of the digital assay. In one embodiment, the pharmaceutical classification platform 101 also considers data ownership when selecting the data set, the interface for accessing the data, or a combination thereof. For example, data ownership authentication may be needed by if participating researchers (e.g., both company researchers and affiliate researchers) negotiate for authenticated access to the data. In one example scenario, it is likely that a research organization or company may enter and/or exit fixed-term contractual agreements pertaining to their research collaboration. In one embodiment, the terms of the contractual agreements may be included as part of the data set itself using, for instance, established standards such as the W3C VoiD and VOAG, or other similar standard. By way of example, some public database operators such as the OpenPhacts foundation provide a pre-competitive knowledge framework for accessing public pharmacological data.

In step 905, the pharmaceutical classification platform 101 prioritizes the target pharmaceutical compound, the target pharmacological effect, the target pharmacological parameter, or a combination thereof based on the one or more linkages, the digital assay, or a combination thereof. Given sufficient data, such digital assays often can be used in place of in vivo and in vitro experiments, or otherwise reduce the need for in vivo and in vitro experiments by screening potential candidate compounds/structures/parameters. The automated prioritization capability provided by the pharmaceutical classification platform 101 help researchers focus on the targets that have the greatest chance of advancing through the pharmaceutical development cycle, thereby advantageously reducing the technical burdens and costs associated with traditionally assaying a compounds for pharmacological effectiveness.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The processes described herein for providing folksonomic object scoring can be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

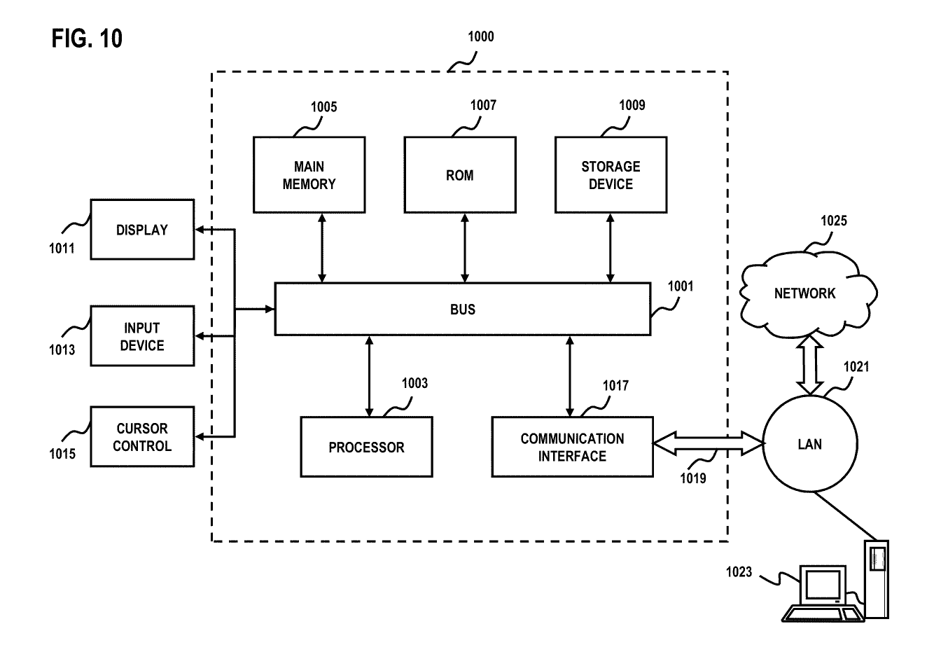

FIG. 10 illustrates computing hardware (e.g., computer system) upon which an embodiment according to the invention can be implemented. The computer system 1000 includes a bus 1001 or other communication mechanism for communicating information and a processor 1003 coupled to the bus 1001 for processing information. The computer system 1000 also includes main memory 1005, such as random access memory (RAM) or other dynamic storage device, coupled to the bus 1001 for storing information and instructions to be executed by the processor 1003. Main memory 1005 also can be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 11 illustrates a chip set 1100 upon which an embodiment of the invention may be implemented. Chip set 1100 is programmed to securely transmit payments and healthcare industry compliant data from mobile devices lacking a physical TSM and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of FIGS. 6-9.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving an input associated with a phase of a pharmaceutical development cycle;
performing a folksonomic tagging of the input to identify a target pharmaceutical compound, a target pharmacological effect, a target pharmacological parameter, or a combination thereof;
constructing a classification query based on the folksonomic tagging;
initiating an application of the classification query to a data set; and
discovering one or more linkages associated with the target pharmaceutical compound, the target pharmacological effect, the target pharmacological parameter, or a combination thereof based on a result of the classification query.

2. A method of claim 1, further comprising:
presenting the one or more linkages via a user interface for a user curation of the one or more linkages.

3. A method of claim 1, further comprising:
calculating a predicted propensity for the target pharmaceutical compound, the target pharmacological effect, the target pharmacological parameter, or a combination thereof based on the application of the classification query, the one or more linkages, or a combination thereof,
wherein the predicted propensity represents a probability that the target pharmaceutical compound, the target pharmacological effect, the target pharmacological parameter, or a combination thereof will be validated with respect to the pharmaceutical development cycle.

4. A method of claim 3, further comprising:
identifying a validation criterion, a test criterion, or a combination thereof associated based on the application of the classification query, the one or more linkages, or a combination thereof,
wherein the predicted propensity is calculated based on the validation criterion, the test criterion, or a combination thereof.

5. A method of claim 1, further comprising:
associating an expiration time parameter, a life time parameter, or a combination thereof with the one or more linkages.

6. A method of claim 1, further comprising:
receiving a request to perform a digital assay of the target pharmaceutical compound, the target pharmacological effect, the target pharmacological parameter, or a combination thereof; and
selecting the pharmacological data, an interface for accessing the pharmacological data, or a combination thereof based on one or more requirements of the digital assay.

7. A method of claim 6, further comprising:
prioritizing the target pharmaceutical compound, the target pharmacological effect, the target pharmacological parameter, or a combination thereof based on the one or more linkages, the digital assay, or a combination thereof.

8. A method of claim 1, further comprising:
deducing a model for the application of the classification query based on the pharmacological data set.

9. A method of claim 8, further comprising:
performing an auto-affine grouping of the pharmacological data set; and
tuning the model based on the auto-affine grouping.

10. A method of claim 1, wherein the application of the classification query is performed via a cloud-based server using an unsupervised predictive model, a supervised predictive model, or a combination thereof.

11. An apparatus comprising a processor configured to:
receive an input associated with a phase of a pharmaceutical development cycle;
perform a folksonomic tagging of the input to identify a target pharmaceutical compound, a target pharmacological effect, a target pharmacological parameter, or a combination thereof;
construct a classification query based on the folksonomic tagging;
initiate an application of the classification query to a pharmacological data set; and
discover one or more linkages associated with the target pharmaceutical compound, the target pharmacological effect, the target pharmacological parameter, or a combination thereof based on a result of the classification query.

12. An apparatus of claim 11, wherein the apparatus is further configured to:
present the one or more linkages via a user interface for a user curation of the one or more linkages.

13. An apparatus of claim 11, wherein the apparatus is further configured to:
calculate a predicted propensity for the target pharmaceutical compound, the target pharmacological effect, the target pharmacological parameter, or a combination thereof based on the application of the classification query, the one or more linkages, or a combination thereof,
wherein the predicted propensity represents a probability that the target pharmaceutical compound, the target pharmacological effect, the target pharmacological parameter, or a combination thereof will be validated with respect to the pharmaceutical development cycle.

14. An apparatus of claim 11, wherein the apparatus is further configured to:
associate an expiration time parameter, a life time parameter, or a combination thereof with the one or more linkages.

15. An apparatus of claim 11, wherein the apparatus is further configured to:
receive a request to perform a digital assay of the target pharmaceutical compound, the target pharmacological effect, the target pharmacological parameter, or a combination thereof; and
select the pharmacological data, an interface for accessing the pharmacological data, or a combination thereof based on one or more requirements of the digital assay.

16. An apparatus of claim 11, wherein the apparatus is further configured to:
deduce a model for the application of the classification query based on the pharmacological data set.

17. An apparatus of claim 16, wherein the apparatus is further configured to:
perform an auto-affine grouping of the pharmacological data set; and
tune the model based on the auto-affine grouping.

18. A system comprising:
a pharmacological database configured to include a pharmacological data set; and
a pharmacological classification platform configured to receive an input associated with a phase of a pharmaceutical development cycle; perform a folksonomic tagging of the input to identify a target pharmaceutical compound, a target pharmacological effect, a target pharmacological parameter, or a combination thereof; construct a classification query based on the folksonomic tagging; initiate an application of the classification query to a pharmacological data set; and discover one or more linkages associated with the target pharmaceutical compound, the target pharmacological effect, the target pharmacological parameter, or a combination thereof based on a result of the classification query.

19. A system of claim 18, wherein the pharmacological classification platform is further configured to present the one or more linkages via a user interface for a user curation of the one or more linkages.

20. A system of claim 18, wherein the pharmacological classification platform is further configured to calculate a predicted propensity for the target pharmaceutical compound, the target pharmacological effect, the target pharmacological parameter, or a combination thereof based on the application of the classification query, the one or more linkages, or a combination thereof; and wherein the predicted propensity represents a probability that the target pharmaceutical compound, the target pharmacological effect, the target pharmacological parameter, or a combination thereof will be validated with respect to the pharmaceutical development cycle.
